(19) United States
(12) Patent Application Publication
(10) Pub. No.: US 2024/0190098 A1
(43) Pub. Date: Jun. 13, 2024

(54) CRIMPING PRESS, AND METHOD FOR PRODUCING A CRIMPED CONNECTION

(71) Applicant: Schleuniger AG, Thun (CH)

(72) Inventor: Marco HÄFNER, Baar (CH)

(73) Assignee: Schleuniger AG, Thun (CH)

(21) Appl. No.: 18/554,277

(22) PCT Filed: Apr. 6, 2022
(86) PCT No.: PCT/IB2022/053220

§ 371 Date: Oct. 6, 2023

(30) Foreign Application Priority Data
Apr. 8, 2021 (EP) 21167397.5

(51) Int. Cl. B30B 1/26

(52) U.S. Cl. CPC B30B 1/266; B30B 1/261

(57) ABSTRACT

The invention relates to a crimping press 20 with a first pressing jaw 60 and with a crimping drive device 26, wherein the crimping drive device 26 comprises a drive element 50 and a drive shaft 44 for moving the drive element 50, and at least one rotatable shaft 42 for moving the first pressing jaw 60, and at least one first bearing system 41, on which the rotatable shaft 42 is mounted rotatably. The first bearing system 41 comprises at least one ball bearing and at least one needle bearing. Furthermore, the invention relates to a method for producing a crimped connection by way of the crimping press, and the use of at least one first bearing system 41 in the crimping drive device 26 of the crimping press 20.

This application is a National Stage completion of PCT/IB2022/053220 filed Apr. 6, 2022, which claims priority from European patent application serial no. 21167397.5 filed Apr. 8, 2021.

### FIELD OF THE INVENTION

The invention relates to a crimping press and a method for producing a crimped connection as well as the use of a bearing system in the crimping drive device of a crimping press.

### BACKGROUND OF THE INVENTION

In order to produce a crimped connection in a crimping press, typically, at least two crimping tools are used that are arranged in the crimping press. The two crimping tools are arranged oppositely on a vertically moveable pressing jaw and on another pressing jaw, which is generally static and is also referred to as an anvil. The area between the two crimping tools is typically called the crimping region.

A crimped connection usually comprises a single-core or multi-core cable and a connecting element, such as a plug, an eyelet or a bushing for example. During a crimping process, the cable is arranged on the connecting element at least in sections and is connected to the connecting element by means of plastic deformation of a section of the connecting element.

For the movement of the vertically moveable pressing jaw in well-known crimping presses, a crimping drive device is usually provided, which usually converts a motor-driven rotational movement of a shaft into the desired linear vertical movement of the pressing jaw. Typically, eccentric kinematics or cam kinematics are used here.

The EP 2843779 A1 discloses a crimping press with cam kinematics, in which a cam roller rolls on a camshaft to move a first pressing jaw. The disadvantage is that there is very little space for mounting the bearing system of the cam roller relative to the pressing jaw. For this reason, this bearing system in this crimping press is only designed with a single rolling bearing, typically a needle bearing. This type of bearing system, usually referred to as “floating bearing system” in the technical literature, cannot absorb axial forces, which would also not be recommended according to “classical” design rules. As a result, the repeatability or precision of the crimping process in this crimping press is incorrect for some cables or cable types.

EP 3 806 250 A1 discloses a crimping press for producing a crimped connection with eccentric kinematics. Here, the force is transmitted to the pressing jaw via a connecting rod, which is rotatably mounted within an eccentric shaft.

### SUMMARY OF THE INVENTION

It is the object of the present invention to remedy one or a plurality of disadvantages of prior art. In particular, the object entails creating a crimping press via which a crimped connection can be produced with improved precision. Furthermore, the object entails creating a crimping press that produces a crimped connection with an improved precision, as well as to create the improved precision through the use of a first bearing system.

At least some of the aforementioned objects are achieved by means of the features of the independent claims. Favourable further embodiments are shown in the figures and in the dependent patent claims.

The crimping press according to the invention comprises a first pressing jaw and a crimping drive device, wherein the crimping drive device comprises a drive element and a drive shaft for moving the drive element, as well as at least a rotatable shaft for moving the first pressing jaw, and at least a first bearing system on which the rotatable shaft is rotatably mounted. The first bearing system comprises at least one ball bearing and at least one needle bearing.

By means of the at least one ball bearing, it is ensured that the bearing system can now also absorb axial forces. This prevents the two elements that can be rotated towards each other, for example, a drive shaft designed as an eccentric shaft and a drive element designed as a connecting rod being prevented from shifting relative to one another in the axial direction, which reduces the bearing clearance of the entire crimping drive device and thus improves the repeatability and thus the precision or quality of crimping.

At least one needle bearing absorbs the radial forces and is much more compact than a ball bearing with a comparable radial load capacity. This significantly reduces the friction losses in the crimping drive device so that the precision of the crimping process is furthermore improved due to the combination of the at least one ball bearing and at least one needle bearing. In addition, with a suitable dimensioning of the at least one ball bearing, the additional installation space required in the crimping drive device is reduced, which enables an improved compact design.

Preferably, the at least one ball bearing and the at least one needle bearing of the first bearing system are arranged adjacent to each other so that a further improved compact design is also possible in the axial direction. The at least one ball bearing and the at least one needle bearing can be arranged next to each other and, where applicable, touch each other, or be spaced a few millimetres apart.

In an embodiment variant (not drawn), the first bearing system comprises another ball bearing, which is arranged adjacent to the at least one needle bearing. The at least one ball bearing is located on one front side of the at least one needle bearing and the other ball bearing on the second front side of the needle bearing so that the axial forces from the first bearing system can be absorbed better. The diameter of the ball bearings can thus be reduced, where applicable, which also contributes to being compact.

Preferably, the at least one ball bearing and the at least one needle bearing of the first bearing system are arranged within a common bearing housing. The common bearing housing accommodates the balls of the at least one ball bearing as well as the needles of the at least one needle bearing so that a more compact design and easy mounting of the first bearing system on the rotating shaft is possible, thereby making it possible to save on manufacturing costs. In this context, the term “bearing housing” is understood to mean the entirety of the inner and outer ring of a rolling bearing, wherein at least one of these two rings can also be designed in a plurality of parts, for example, with the outer ring as a single piece and the inner ring in two parts, wherein a separation point can be present in the area of the balls of the at least one ball bearing.

Preferably, at least one needle bearing comprises a plurality of needles that have a length/diameter ratio of 2.5 to 10.

As a result, these bearings make a very compact design possible with a high level of force absorption simultaneously in the radial direction to the rotatable shaft.

Preferably, the first bearing system is located within the drive element in the first pressing jaw or in the drive shaft. Thus, the drive element is axially defined or determined relative to the first pressing jaw. This leads to an improvement in the precision of crimping due to the reduced bearing clearance in the bearing system of the rotating shaft. For example, the first bearing system is arranged in the drive shaft and one end of the rotating shaft is rotatable in the first bearing system, and the second end of the rotating shaft is pressed into the drive element in such a way that it is kept stable there. Alternatively, the first bearing system is arranged within the drive element and one end of the rotatable shaft is rotatable in the first bearing system, and the second end of the rotatable shaft is pressed into the drive shaft in such a way that it is kept stable there.

Preferably, the drive element is a connecting rod or a cam roller so that a motor-driven rotational movement of the drive shaft can be easily converted into the desired linear vertical movement of the first pressing jaw.

Preferably, the connecting rod comprises another rotatable shaft, which is rotatable in another bearing system and also comprises at least one ball bearing and at least one needle bearing. Thus, the connecting rod is axially defined or determined in both the first as well as in the other bearing system relative to the drive shaft and relative to the first pressing jaw, wherein the entire crimping drive device is overdetermined by one degree of freedom. Surprisingly, this leads to an improvement in the precision of crimping due to the reduced bearing clearance of the two bearing systems, since the gain in precision due to the reduced bearing clearance in the entire crimping drive device is significantly higher than the loss due to the overdetermination having been made.

Preferably, the drive shaft is an eccentric shaft or a camshaft. The embodiment with eccentric kinematics, i.e., with eccentric shaft and connecting rod, enables power to be transmitted to the pressing jaw in both directions, which means that there is no need for a passive force element to generate a restoring force. The connecting rod can be mounted with at least two bearing systems.

In the embodiment with cam kinematics, i.e., with camshaft and cam roller, only one bearing system in the area of the cam roller is necessary. For this, a passive force element is favourable to ensure contact between the cam roller and the camshaft, for example a return spring.

In general, the embodiment with cam kinematics allows a somewhat more compact design and the embodiment with eccentric kinematics a slightly better precision.

Preferably, a passive force element is present, with which a force in the direction of the drive shaft can be generated in the area of the first pressing jaw or in the area of the drive element. The passive force element ensures contact between the cam roller and the camshaft so that an improved crimped connection can be produced. For example, the passive force element is a return spring or a magnet. In the embodiment as a return spring, the passive force element is preferably connected to a connecting structure of the crimping press.

Preferably, a guide device is available to guide the first pressing jaw along its operating route. The first pressing jaw is guided linearly along the guide device and comprises a guide section, which engages with a guide rail of the guide device. This makes it possible to move the first pressing jaw precisely towards the second pressing jaw, wherein this movement can be carried out reproducibly due to the first bearing system, as the bearing clearance is improved. For example, the guide device is a sliding guide device.

A method according to the invention for producing a crimped connection with a crimping press, as described herein, enables the precise movement of the first pressing jaw towards the other pressing jaw or towards the second pressing jaw so that a reproducible crimped connection can be produced.

An use of a bearing system according to the invention consists of the at least one ball bearing and at least one needle bearing in a crimping drive device of a crimping press. By means of the at least one ball bearing, it is ensured that the bearing system can now also absorb axial forces. This prevents the two elements that can be rotated towards each other, for example, a drive shaft designed as an eccentric shaft and a drive element designed as a connecting rod being prevented from shifting relative to one another in the axial direction, which reduces the bearing clearance of the entire crimping drive device and thus improves the repeatability and thus the precision or quality of crimping. At least one needle bearing absorbs the radial forces and is much more compact than a ball bearing with a comparable radial load capacity. This reduces the installation space required in the crimping drive device, which enables an improved compact design.

Further advantages, features and details of the invention arise from the following description, in which exemplary embodiments of the invention are described with reference to the drawings. Enumerations such as first, second, third or others are only used to identify the components.

The reference list is also an integral part of the disclosure like the technical content of the patent claims and figures are. The figures are comprehensively described in relation to one another. Identical reference numbers denote identical components, and reference numbers having different indices indicate functionally identical or similar components.

### BRIEF DESCRIPTION OF THE DRAWINGS

The figures show:

FIG. 1 a first embodiment of a crimping press according to the invention in a schematic sectional illustration,

FIG. 2 another embodiment of a crimping press according to the invention in a schematic sectional illustration,

FIG. 3a a front view of the crimping press in accordance with FIG. 1, in a first position,

FIG. 3b a front view the crimping press in accordance with FIG. 1, in a second position,

FIG. 4 another embodiment of a crimping press according to the invention in a schematic sectional illustration,

FIG. 5a a front view of the crimping press in accordance with FIG. 4, in a first position and

FIG. 5b a front view of the crimping press in accordance with FIG. 4, in a second position.

### DETAILED DESCRIPTION OF THE PREFERRED EMBODIMENTS

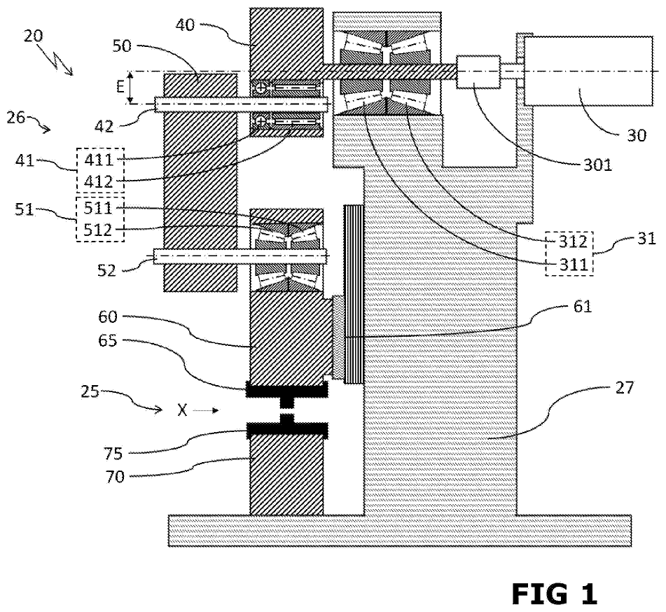

FIG. 1 shows a crimping press 20 with a connecting structure 27 and a crimping area 25, in which two crimping tools 65, 75 are arranged on a pressing jaw 60, 70 each and are moved relative to each other to produce a crimped connection. The lower crimping tool 75, also called “anvil”, is attached to the lower pressing jaw 70, which in turn is connected to the connecting structure 27. The upper crimping tool 65 is arranged on the upper pressing jaw 60, which is vertically moveable by means of a crimping drive device 26 relative to the connecting structure 27 and to the lower pressing jaw 70 with the lower crimping tool 75 attached to it. For this purpose, the movement of the upper pressing jaw 60 is guided vertically by means of a linear guide device 61, here designed as a sliding guide.

The crimping drive device 26 comprises a crimping drive 30, which actively rotates a drive shaft 40 around its axis, a drive element 50 designed as a connecting rod, as well as other elements for mechanical force and torque transmission, namely the rotatable shafts 42, 52, the bearing systems 31, 41, 51 and a compensating coupling 301. The crimping drive 30 is connected to the connecting structure 27 and preferably designed as an electric motor with flange-mounted planetary gear and preferably comprises a rotary encoder. Alternative motors or drives, which are used for crimping presses, can also be used. The crimping drive 30 is electrically connected to a control and control device, which, in turn, communicates with a central control system of the crimping press 20 and/or a higher-level machine or system control system (not shown). This crimping drive 30 rotates the drive shaft 40, wherein misalignment due to assembly and/or manufacturing tolerances are typically compensated by a compensating coupling 301. The drive shaft 40 is rotatable and axially defined in the connecting structure 27, with the help of the bearing system 31, here designed as a pair of two tapered rolling bearings 311, 312 in an O-arrangement.

In this context, “Axial” means: Parallel to the axis of rotation of the respective rotatable shaft. The axes of rotation of the drive shaft 40 and the rotatable shafts 42, 52 are aligned parallel to each other and parallel to the cable axis X, which is specified by the longitudinal extension of the cable during the crimping process.

The drive element 50, which is designed as a connecting rod, is rotatably mounted relative to the drive shaft 40, wherein the axis of rotation of the connecting rod 50 and the axis of rotation of the drive shaft 40 are arranged parallel to each other and are offset around the centre distance or eccentricity E. For this reason, the drive shaft 40 is also usually called an eccentric shaft by people skilled in the art, the associated kinematics is called eccentric kinematics and the crimping press 20 driven in this way is called eccentric press. At its other end, the connecting rod 50 is rotatably mounted relative to the pressing jaw 60.

In the case of both axes of rotation, a rotatable shaft 42, 52 is attached to the connecting rod 50, preferably pressed, which rotates in a bearing system 41, 51, which is connected to the respective adjacent part, i.e., the drive shaft 40 designed as an eccentric shaft and the moveable pressing jaw 60. The bearing system 51 in the moveable pressing jaw 60 is designed as a pair of two tapered rolling bearings 511, 512 in an O-arrangement. The bearing system 41 in the eccentric shaft 40 is designed as a fixed-floating bearing, with the fixed bearing 411 designed as a ball bearing and the floating bearing 412 designed as a needle bearing.

The two shorter, rotatable shafts 42, 52 are also often referred to as “axes” because they do not transmit torque—in contrast to the drive shaft 40.

In this document, the term “needle bearing” refers to rolling bearings with slender cylindrical rolling elements, which are very long compared to their diameter. Typically, the length/diameter ratio is a factor of 2.5 to 10, which is why these rolling elements are also referred to as “needles” and the associated bearing is referred to as “needle bearings”. As a result, these bearings enable a very compact design simultaneously with high force absorption in the radial direction and differ from the “normal” cylindrical rolling bearings with shorter rollers, often also referred to as “spherical rolling bearings”.

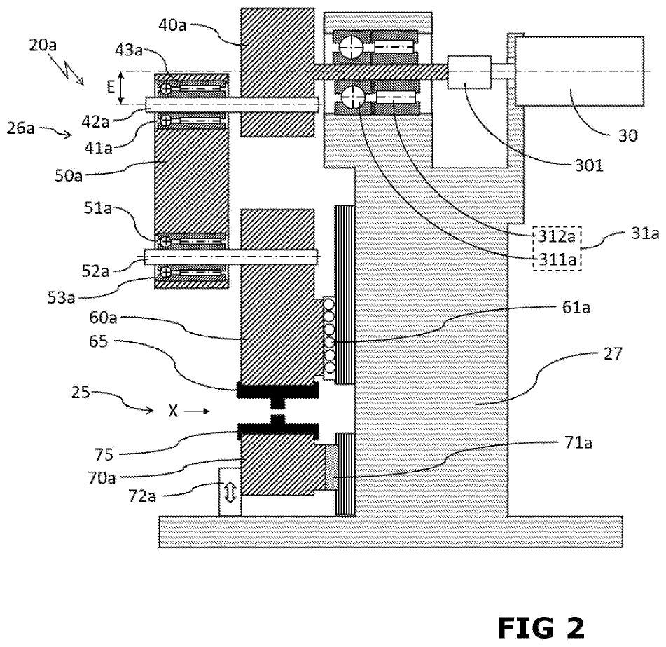

FIG. 2 shows an alternative embodiment of a crimping press 20a with an alternative crimping drive device 26a. This uses the same kinematics as the crimping drive device 26 in accordance with FIG. 1. However, the rotating shafts 42, 52 are arranged differently, as well as the bearing systems 31a, 41a, 51a and the linear guide device 61a, as disclosed below. Furthermore, the other pressing jaw 70a is vertically guided in another guide device 71a and can be moved with the help of another crimping drive device 72a.

The bearing system 31a of the drive shaft 40a, which is designed as an eccentric shaft, in the connecting structure 27 is also implemented here as a fixed-floating bearing system, with the fixed bearing 311a designed as a ball bearing and the floating bearing 312a designed as a cylindrical rolling bearing or spherical rolling bearing.

The rotatable shaft 42a is fixed or pressed into the drive shaft 40a, which is designed as an eccentric shaft, and the rotatable shaft 52a is fixed or pressed into the moveable pressing jaw 60a, whereas the corresponding bearing systems 41a, 51a are connected to the drive element designed as a connecting rod 50a or are arranged in the connecting rod 50a. Both bearing systems 41a, 51a each have a common bearing housing, wherein both the needle bearing as well as the ball bearing are arranged in a common bearing housing 43a, 53a or share the same inner or outer ring. In other words, the bearing system 41a between the drive shaft 40, which is designed as an eccentric shaft, and the connecting rod 50 is designed as a combined needle-ball bearing, in which a needle bearing, and a ball bearing are combined within a common bearing housing 43a. In this context, the term “bearing housing” is understood to mean the entirety of the inner and outer ring of a rolling bearing, wherein at least one of these rings can also be designed in a plurality of parts, for example, with the outer ring as a single piece and the inner ring in two parts with the separation point in the area of the spherical rolling elements.

The bearing system 51a between connecting rod 50 and pressing jaw 60 is also designed with such a combined needle-ball bearing and comprises a common bearing housing 53a.

The linear guide device 61a between the moveable pressing jaw 60 and connecting structure 27 is designed as a recirculating ball bearing guide with a matching rail.

The remaining elements of the alternative crimping drive device 26a are functionally and structurally identical to those of the crimping drive device 26 in accordance with FIG. 1.

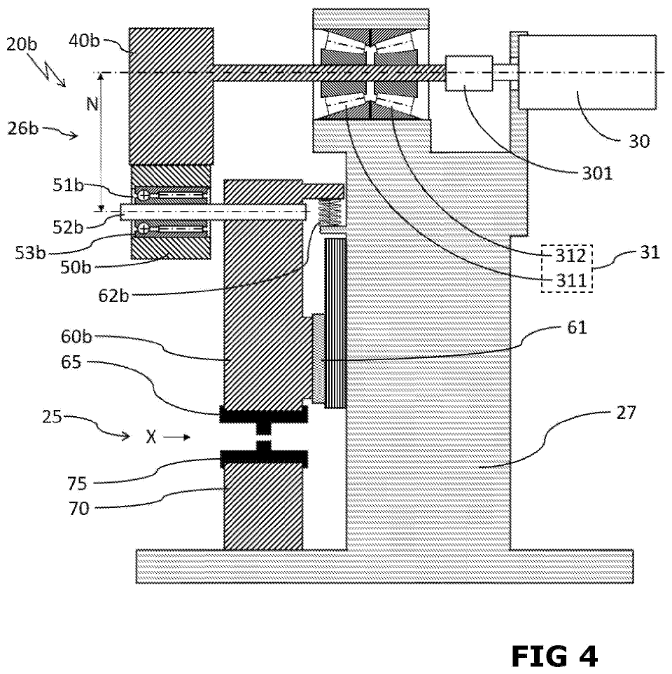

The other pressing jaw 70a is vertically guided in another guide device 71a and can be moved with the help of another crimping drive device 72a. This other crimping drive device 72a is only schematically represented by a block arrow. Eccentric or cam kinematics are also conceivable here as a specific embodiment, i.e., similar to that described for the crimping drive devices 26, 26a, 26b (see FIG. 4). Alternatively, an alternative drive kinematics with a toggle lever or a wedge, and/or the associated drive element is also possible as a simple pneumatic cylinder, as described for example in EP 3 806 250 A1.

In addition or as an alternative, embodiments of the crimping press shown above are possible, which comprise a wide variety of combinations and intermediate variants with the elements of the two drawn crimping presses 20, 20a, for example, with a connecting rod which comprises a bearing system on one side and a shaft pressed in on the other side, or with another bearing system as described above with a ball bearing and a needle bearing between the eccentric shaft and the connecting structure. In the case of this bearing system, a spherical rolling bearing can also alternatively be used as a fixed bearing instead of the ball bearing. The arrangement of a pair of tapered rolling bearings in an X-arrangement is also conceivable. Of course, the crimping drive device 26 can also be combined with a moveable lower pressing jaw 70a. It is also possible to use a plain bearing in the case of the bearing system between the connecting rod and the pressing jaw.

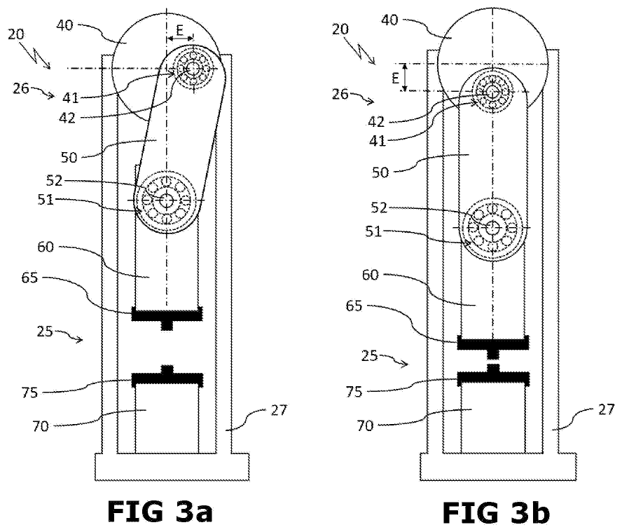

On the basis of FIGS. 3a, 3b, a method for producing a crimped connection with a crimping press 20 in accordance with FIG. 1 is now described.

In this case, the upper pressing jaw 60 is guided to the lower pressing jaw 70 by means of the crimping drive device 26 so that the two crimping tools 65, 75 can produce the crimped connection.

FIG. 3a shows the upper pressing jaw 60 of the crimping press 20 in a middle position and FIG. 3b shows it in the crimping position. In order to transfer the pressing jaw 60 to the crimping position, the drive shaft 40, which is designed as an eccentric shaft, is rotated clockwise by 90°, and the driving force is transmitted to the pressing jaw 60 by means of the connecting rod 50, wherein the connecting rod 50 is rotatable in both the eccentric shaft 40 as well as the pressing jaw 60, by means of the two bearing systems 41, 51 and the rotatable shafts 42, 52.

FIG. 4 shows another alternative embodiment of a crimping press 20b with an alternative crimping drive device 26b.

This uses cam kinematics in which there is no connecting rod with the associated shafts and bearing systems. Instead, a drive element 50b designed as a cam roller rolls on a drive shaft 40b designed as a camshaft, which is rotatably mounted around the moveable pressing jaw 60b.

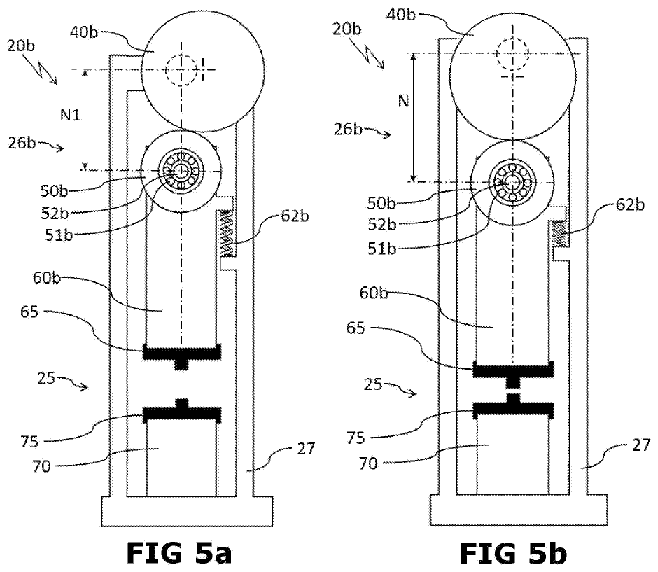

The outer contour of the drive shaft 40b, which is designed as a camshaft, is acentric to its axis of rotation (see FIG. 5), wherein the distance N, Ni (FIG. 5a) between the axes of rotation of the camshaft 40b and the cam roller 50b changes when the camshaft 40b is rotated. Thus, the rotational movement of the camshaft 40b generates a linear movement of the pressing jaw 60b. In order to ensure contact between camshaft 40b and cam roller 50b at all times, a passive force element 62b is provided, shown here as a return spring between the moveable pressing jaw 60b and the connecting structure 27, preferably designed as a spiral compression spring.

In addition, or as an alternative, a magnet can also be used as a passive force element 62b and/or the camshaft and/or cam roller can be supplemented with magnetic adhesive elements.

The rotatable shaft 52b for the cam roller 50b is attached to the pressing jaw 60b or pressed into it. The bearing system 51b is attached to the cam roller 60b or pressed into it. In the embodiment drawn herein, this bearing system 51b is designed as a combined needle-ball bearing, similar to bearing systems 41a, 51a in FIG. 2.

Alternatively, it is also possible to design the bearing system 51b as a combination with two separate rolling bearings, in separate bearing housings, similar to those shown in FIG. 1 in the case of the bearing system 41. It is also possible to fix the bearing system in the pressing jaw and the shaft in the cam roller, wherein in this embodiment the shaft and cam roller can also be designed as a common rotary part.

The remaining elements of the alternative crimping drive device 26b are functionally and structurally identical to those of the crimping drive device 26.

Here, all conceivable combinations with elements from the other two crimping presses 20, 20a are also possible and useful, with exemplary embodiments already described in the description text for FIG. 2.

On the basis of FIGS. 5a, 5b, a method for producing a crimped connection with a crimping press 20b in accordance with FIG. 4 is now described. The upper pressing jaw 60b is guided to the lower pressing jaw 70 by means of the crimping drive device 26b so that the two crimping tools 65, 75 can produce the crimped connection.

FIG. 5a shows the upper pressing jaw 60b of the crimping press 20b in a middle position and FIG. 5b shows it in the crimping position. In order to transfer the pressing jaw 60b to the crimping position, the drive shaft 40b, which is designed as a camshaft, is rotated clockwise by 90°, and the driving force is transmitted to the pressing jaw 60b by means of the cam roller 50b rolling off it, wherein the cam roller 50b is rotatably mounted in the pressing jaw 60b, by means of the bearing system 51 and the rotatable shaft 52. The contact between cam roller 50b and camshaft 40b is ensured by the passive force element 62b.

### REFERENCE LIST

20, 20a-b crimping press
25 crimping area
26, 26a-b crimping drive device
27 connecting structure
30 crimping drive (gear motor)
301 compensating coupling
31, 31a bearing system (bearing pair)
311, 311a rolling bearings (tapered rolling bearings, fixed bearings, ball bearings)
312, 312a rolling bearings (tapered rolling bearings, floating bearings, cylindrical rolling bearings)
40, 40a drive shaft (eccentric shaft)
40b drive shaft (camshaft)
41, 41a bearing system (bearing pair, combined needle-ball bearing)
411 rolling bearings (fixed bearings, ball bearings)
412 rolling bearings (floating bearings, needle bearings)
42, 42a rotatable shaft (axis)
43a bearing housing
50, 50a drive element (connecting rod)
50b drive element (cam roller)
51, 51a-b bearing system (pair of bearings, combined needle-ball bearing)
511, 512 rolling bearings (tapered rolling bearings)
52, 52a-b rotatable shaft (axis)
53a-b bearing housing
60, 60a-b (first, upper) pressing jaw
61, 61a (linear) guide device
62b passive force element (return spring, magnet)
65 (first, upper) crimping tool
70, 70a (other, lower) pressing jaw
71a (linear) guide device
72a other crimping drive device
75 (other, lower) crimping tool (anvil)
E (centre distance) (in eccentric shaft, eccentricity)
N, N1 (centre) distance (for camshaft, depending on the angle of rotation)
X cable axis (axial direction)

1-12. (canceled)

13. A crimping press (20, 20a, 20b) comprising a first pressing jaw (60, 60a, 60b) and comprising a crimping drive device (26, 26a, 26b), wherein the crimping drive device (26, 26a, 26b) comprises a drive element (50, 50a, 50b) and a drive shaft (40, 40a, 40b) for moving the drive element (50, 50a, 50b) and at least one rotatable shaft (42, 42a, 42b, 52, 52a, 52b) for moving the first pressing jaw (60, 60a, 60b) as well as at least one first bearing system (41, 41a, 51a, 51b) on which the rotatable shaft (42, 42a, 42b, 52, 52a, 52b) is rotatably mounted, wherein the drive shaft (40, 40a, 40b) and the rotatable shaft (42, 42a, 42b, 52, 52a, 52b) are both rotatable in relation to each other, and the first bearing system (41, 41a, 51a, 51b) comprises at least one ball bearing and at least one needle bearing.

14. The crimping press according to claim 13, wherein the at least one ball bearing and at least one needle bearing of the first bearing system (41, 41a, 51a, 51b) are arranged adjacent to each other.

15. The crimping press according to claim 13, wherein the at least one ball bearing and the at least one needle bearing of the first bearing system (41, 41a, 51a, 51b) are arranged in a common bearing housing (43a, 53a, 53b).

16. The crimping press according to claim 13, wherein the at least one needle bearing comprises a plurality of needles having a length/diameter ratio of 2.5 to 10.

17. The crimping press according to claim 13, wherein the first bearing system (41, 41a, 51a, 51b) is arranged within the drive element (50, 50a, 50b) in the first pressing jaw (60, 60a, 60b) or in the drive shaft (40, 40a).

18. The crimping press according to claim 13, wherein the drive element (50, 50a, 50b) is a connecting rod (50, 50a) or a cam roller (50b).

19. The crimping press according to claim 18, wherein the connecting rod (50, 50a) comprises another rotatable shaft (42, 42a, 52, 52a) that is rotatably mounted in another bearing system (41, 41a, 51a) and also comprises at least one ball bearing and at least one needle bearing.

20. The crimping press according to claim 18, wherein the drive shaft (40, 40a, 40b) is an eccentric shaft (40, 40a) or a camshaft (40b).

21. The crimping press according to any claim 13, wherein a passive force element (62b) is present that generates a force in a direction of the drive shaft (40b) in an area of the first pressing jaw (60b) or in an area of the drive element (50b).

22. The crimping press according to claim 13, wherein a guide device (61, 61a) is provided for guiding the first pressing jaw (60, 60a, 60b) along its operating route.

23. A method for producing a crimped connection with a crimping press (20, 20a, 20b) according to claim 13, wherein the first pressing jaw (60, 60a, 60b) is moved to another pressing jaw (70, 70a) to produce a crimped connection.

24. Use of a bearing system (41, 41a, 51a, 51b) consisting of at least one ball bearing and at least one needle bearing in a crimping drive device (26, 26a, 26b) of a crimping press (20, 20a, 20b).
